(19) United States
(12) Patent Application Publication
(10) Pub. No.: US 2006/0257607 A1
(43) Pub. Date: Nov. 16, 2006

(54) Partially secured label rolls and fanfolds and methods of making same

(75) Inventors: Tamra F. Crooks, Foristell, MO (US); Kevin J. Gold, Chesterfield, MO (US)

Correspondence Address: Levenfeld Pearlstein, LLC (ILLINOIS TOOL WORKS), 2 North LaSalle Street, Suite 1300, CHICAGO, IL, 60602, US

(73) Assignee: Illinois Tool Works, Inc., Glenview, IL (US)

(21) Appl. No.: 11/127,640

(22) Filed: May 12, 2005

(51) Int. Cl. B32B 33/00; B32B 23/02

(52) U.S. Cl. 428/40.1; 428/194

(57) ABSTRACT

A partially adhered label includes a carrier web and a substrate carried by the web. The substrate has a smaller area than an area of the carrier web. The substrate defines an outer indicia carrying surface and an inner surface. The inner surface is partially adhered to the carrier web by an adhesive. The inner surface of the substrate defines an active adhesive area and a central non-adhesive area. The adhesive area is by a border extending around a periphery of the non-adhesive area.

### BACKGROUND OF THE INVENTION

The present invention pertains to adhesive labels. More particularly, the present invention pertains to partially secured labels and a method of making partially secured labels.

Pressure sensitive labels are used in all manners of everyday life. For example, these labels are in wide spread use in manufacturing, retail merchandising, and warehousing. These labels can be used in marketing, product identification, tracking, sorting, and point-of-purchase displays.

Point-of-purchase displays typically place consumer goods in close proximity to the consumer. The display and marketing uses of labels allow consumers to come into contact with labels through incidental contact or by detaching a portion of the label without having active adhesive come into contact with the consumer. Contact with active adhesive would be perceived as negative by the consumer.

For example, shelf-mounted labels commonly identify products and include information as quantity, pricing and the like. These labels are often posted or positioned on the edge or lip of a shelf. In many instances, the shelf lip is quite narrow (about one inch), whereas it is desired to place a larger label (for example, two to three inches) on the shelf to draw a consumer's attention. In addition, certain types of retail businesses, such as grocery stores and discount merchandisers, experience frequent price changes. Consequently the point-of-purchase displays are frequently relabeled in many such establishments.

Known labels include a substrate (such as a paper or polymer element) on which indicia is printed. The substrate is carried on a web to facilitate printing, transport and transfer onto an object to be labeled (marked). The web has a release coat thereon and the label has a layer of adhesive on a surface of the label adjacent to the release coat. The adhesive can be a pressure sensitive adhesive such that following separation from the carrier, the label is pressed to the object to adhere the label to the object.

In such known labels, the adhesive extends over the entirety of the rear side of the substrate. To use the label, the substrate is separated from the carrier web and the substrate is applied to the object.

One drawback to known labels is that the entirety of the label substrate is adhered to the object. In addition, inadvertent contact (of a consumer) with the label adhesive can negatively influence the consumer. Moreover, where only a portion of the label is to be adhered to the object (for example when only a portion of a label is to be adhered to a shelf lip), either a portion of adhesive exposed label hangs from the shelf, or some way to cover the exposed adhesive must be devised. One known label is a sheet formed label in which a portion (for example an upper one-third) of the label has adhesive applied thereto, and the remaining portion of the label is fabricated without the adhesive. While such a label may function well, it may not be usable with different types of labeling equipment (e.g., label printers or applicators) used by end users.

Accordingly, there is a need for a partially-secured label. Desirably, such a label is available in roll or fanfold (stack) form. Most desirably, such a label is manufactured using principally known label manufacturing methods, and is usable with various types of labeling equipment, printers and applicators.

### BRIEF SUMMARY OF THE INVENTION

A partially adhered label includes a carrier web and a substrate carried by the web. The substrate has a smaller area than an area of the carrier web. The substrate defines an outer indicia carrying surface (onto which printing can be applied) and an inner surface. The inner surface is partially adhered to the carrier web by an adhesive.

The substrate defines an active adhesive area and a central non-adhesive area. The adhesive area is by a border extending around a periphery of the non-adhesive area.

The present label provides a partially-secured label in roll or fanfold (stack) form. Such a label is manufactured using principally known label manufacturing methods, and is usable with various types of labeling equipment, printers and applicators.

The border is contiguous and surrounds the central non-adhesive area. The adhesive border can be continuous (as in a picture frame) or it can be discontinuous (as in striped, e.g., applied in discrete spaced locations) and surrounding the central non-adhesive area.

The non-adhesive area can be effected by application of an adhesive deadening agent is applied to the substrate inner surface. Alternately, the carrier web has a frangible line formed therein that is coextensive with the label non-adhesive area. In such an arrangement, the substrate is separated from the carrier web and the a portion of the web underlying the substrate is separated from the carrier web at the frangible line to effect the non-adhesive area.

The substrate is in the shape of a rectangle (e.g., square) having rounded corners and the adhesive region is likewise has rounded corners inwardly of a periphery of the substrate.

The carrier web can be formed as an elongated strip having a plurality of substrates carried by the web. The substrates are spaced from one another along the length of the carrier web. In this arrangement, each of the substrates can be separated from adjacent substrates by frangible lines in the carrier web.

The label (substrate) is readily removed from the carrier (by the rounded corners), and can be applied and removed from the object (such as a grocery store self) by the partial adhesive.

These and other features and advantages of the present invention will be apparent from the following detailed description, in conjunction with the appended claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is a portion of a label roll having a plurality of partially secured labels embodying the principles of the present invention;

FIG. 2 is a plan view of a single label on its carrier;

FIG. 3 is a plan view of a label as in FIG. 2, but showing a partially label adhered border;

FIG. 4 is a cross-sectional view of the label of FIG. 2;

FIG. 5 is a perspective view of the labels in an inside wind roll form; and

FIG. 6 is a perspective view of the labels in one back fan fold form.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description Of The Invention”, relates to a requirement of the United States Patent Office, and does not imply, nor should be inferred to limit the subject matter disclosed herein.

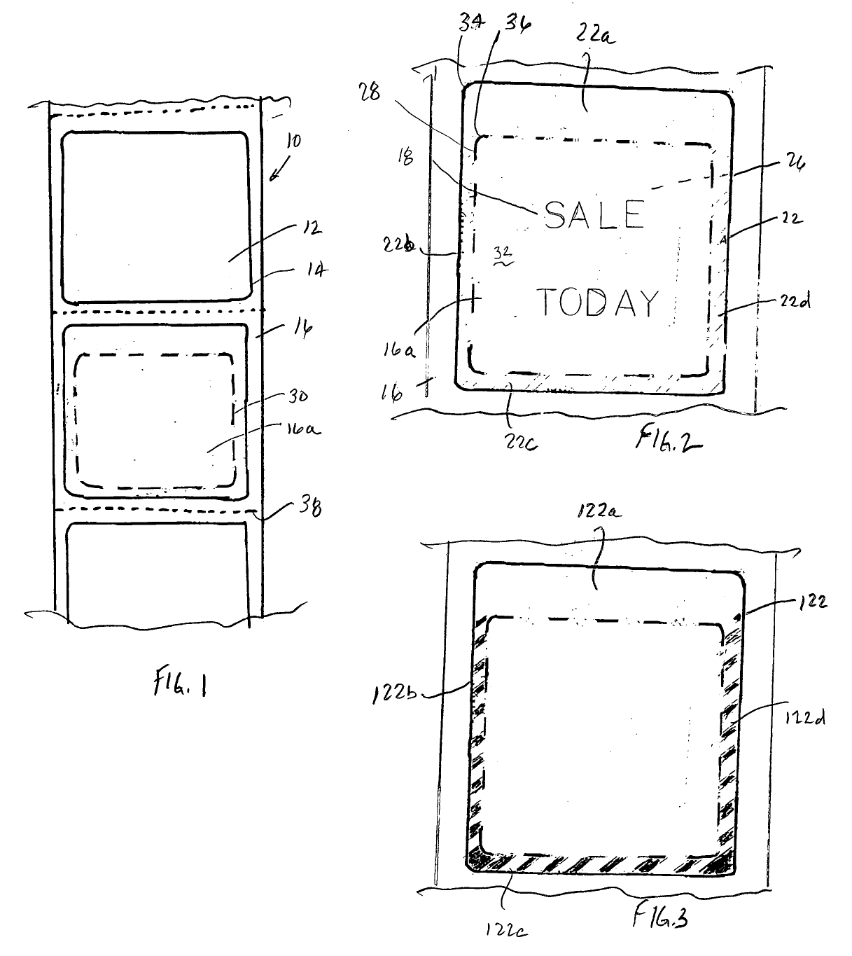

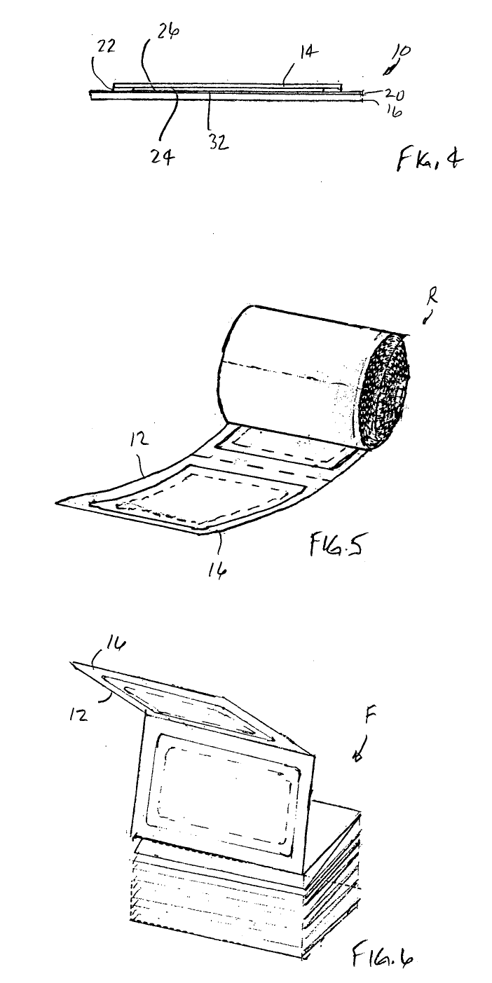

Referring now to the figures and in particular to FIG. 1, there is shown a portion 10 of a label strip or roll having a plurality of partially secured labels 12 embodying the principles of the present invention. The labels 12 each are formed having a face stock layer (substrate) 14 and a carrier web or liner 16. The face stock layer or substrate 14 is the layer onto which indicia 18 (e.g., printing) is applied. The substrate 14 can be a paper or paper-based material, a polymeric material or the like. Those skilled in the art will recognize the various materials from which such a label 12 can be fabricated. A typical label carrier web 16 is formed having a release coat 20 (such as a silicone coat thereon, see e.g., FIG. 4) to facilitate removing the adhesive-backed label 12 from the web 16.

The present invention provides a label 12 that is resistant to distortion, misuse or undesirable results from environmental and other causes. A method of manufacturing partially-secured labels 12 is efficient in material and labor costs.

The label substrate 14 is formed as a discrete unit on the web 16. That is, the substrate 14 does not cover the entirety of the web 16, but is a discrete label 12 “unit” disposed on the web 16.

The substrate 14 has a layer of adhesive 22 applied thereto to provide a partially-secured label. As such, the label 12, in use, has adhesive active or exposed (as at 22) on only a portion of the rear 24 of the substrate 14 and the remaining portions 26 of (the rear) of the label 12 are non-adhesive. The selective adhesive 22 is provided in a picture frame manner, with a central, substantially enclosed inactive adhesive area 26 surrounded by a contiguous border or frame of active adhesive area(s) 22a, 22b, 22c, 22d. It will be appreciated that in the figures, an inner border 28 of the adhesive 22 is shown in phantom (dashed) lines to indicate that, as viewed from the front of the substrate 14 (or label 12), the order or frame of adhesive 22 is not visible.

In one embodiment, the entirety of the border 22 is adhesive. Alternately, as seen in FIG. 3, the border 122 can have one or more sides or legs 122b, 122c, 122d that are contiguous, but are discontinuous, that is, partially active (and partially inactive) as by striping (or making active) the adhesive along that leg or those legs, and (at least) one leg 122a that is fully active adhesive. In such an arrangement, the adhesive striping can be applied in discrete, spaced locations and may include a larger active area at the corners (see enlarged stripped area at corners in FIG. 3).

The inactive area or areas 26 can be formed by a variety of means. For example, the inactive areas 26 can be formed by the application of a deadener or an abhesive 32 (a substance that prevents materials from sticking to one another) on the adhesive in those area in which inactive adhesive is desired. Alternately, the adhesive 22 can be selectively applied so that it is not applied in the areas 26 in which inactive adhesive is desired. Alternately still, it may be desirable to form the labels 12 so that the liner 16 remains adhered to the substrate 14 in those areas 26 in which inactive adhesive is desired. In such a configuration, the liner 16 may have a frangible border (as indicated at 30) so that the liner 16 separates at the frangible border 30 with a portion of the liner 16a remaining on the substrate 14 desired overlying the unadhered area 26.

In a preferred form of the label 12 the inactive areas 26 are treated with (have applied thereto) an abhesive 32 in the desired inactive areas 26 in addition to which that portion of the liner 16a that corresponds to the desired inactive area 26 is capable of being separated from the remainder of the web 16 so as to remain affixed to the substrate 14 when it is separated from the web 16. In this manner, one form of the label can be used in either application, that is, with the liner 16 removed (and an adhesive deadening agent 32 applied) and with the liner 16a retained in place on the label 12 as it is used.

The label 12 is formed having rounded corners as indicated at 34. In addition, the adhesive 22 border or frame area is also formed with rounded inner corners (as at the adhesive region 22/non-adhesive region 26 interface). The rounded corners 34, 36 facilitate removing the substrate 14 from the web 16 for use.

Those skilled in the art will recognize the methods that are used to form labels 12. The substrate 14 can be applied to the web 16 as a continuous sheet or element and then cut to form the discrete labels 12. The cut is commonly referred to as a kiss cut, in which the cut is only into the substrate 14 and does not sever the web 16 (or only partially severs the web). Alternately, if a portion of the web or liner 16a is to remain affixed to the label 12, the cut may be made sufficiently through the liner 16 material (e.g., forming a frangible line or border 30) to facilitate separating the label 12 with the liner portion 16a from the remainder of the liner 16. The labels 12 can be formed by delaminating a laminated material (substrate 14/adhesive 22/carrier web 16), selectively applying an adhesive deadening material 32 (for example an abhesive) to desired areas 26 of the substrate 14 over the adhesive, and relaminating the face stock or substrate 14 and the carrier 16.

Following cutting the substrate 14 to define the labels 12, the remainder of the substrate outside of the label 12 (waste) is removed from the web 16, thus forming the discrete labels 12. Frangible regions (e.g., score lines) 38 can be formed in the web 16, between the labels 12, to facilitate separating the labels 12 while on the web 16, for one another.

As set forth above, at times may be desirable to retain a portion of the liner 16a on that portion 26 of the label 12 unadhered to the object. For example, when a label 12 is applied to a shelf in a refrigerated cooler or other refrigerated or humid area, a thin paper label may tend to curl. Thus, although the label would otherwise serve the display or advertising function, it could be aesthetically unappealing. By leaving a portion of the liner 16a on the label 12 (at the unadhered portion 26), the label 12 is provided with additional thickness, strength, and rigidity. As such, the likelihood or extent of curling is reduced by the retained liner portion 16a.

Moreover, as set forth above, one annoyance that has been observed is that a consumer or user could brush by or inadvertently contact the rear 24 of the label 12 which, if it has adhesive, could adhere to the individual. In such an instance, the label 12 could be accidentally removed from the shelf. The inactive are 26 prevents this inadvertent sticking. Further, the inactive label region 26 also provides an area for, for example, an employee to grasp the label 12 to remove it from the shelf, without the label 12 sticking to the employee's hand or fingers.

Advantageously, the present invention provides a partially-secured label 12 (in roll R or fan-folded stack F form). The labels 12 are formed having a portion 26 that is unadhered or deadened, forming a non-adhesive portion. Such a label 12 minimizes the labor necessary to remove the substrate 14 from a liner or backing sheet 16 and place the label 12 on, for example, a shelf display or the like. Such a label 12 increases the efficiency by which the labeling operation can be carried out. Labels 12 in accordance with the present invention are economical to manufacture and particularly well suited for either preprinting (as printed during manufacture) or on-site printing (as printed by customer or end-user at a desired location such as a place of business).

As shown in FIG. 5, the roll R is formed in an inside roll form, in which the labels 12 are on the inside of the roll R. Those skilled in the art will recognize that the roll R can be formed in an outside roll form in which the labels are on the outside of the roll. With respect to the fan-folded F form, the fan-fold stack F shown in FIG. 6 is a one back form in which one label 12 is positioned between each fold or change in direction. Again, those skilled in the art will recognize that a multi-back (e.g., two back) form fold stack can be used for the present invention as well.

Additionally, the unique pattern and design of the inactive areas 26 works in complementary fashion with the requirements of print technology useful to the above-noted marketplaces. Active adhesive areas 22 are required to manufacture the label and to allow imprinting of the label. Inactive areas 26 allow marketing and consumer contact with the label while avoiding undesirable side affects.

All patents referred to herein, are hereby incorporated herein by reference, whether or not specifically do so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

What is claimed is:

1. A partially adhered label comprising:
a carrier web; and
a substrate carried by the carrier web, the substrate having a smaller area than an area of the carrier web, the substrate defining an outer indicia carrying surface and an inner surface, the inner surface being partially adhered to the carrier web by an adhesive, the substrate defining an active adhesive area and a central non-adhesive area, the adhesive area defined by a border extending around a periphery of the non-adhesive area.

2. The label in accordance with claim 1 wherein the border is contiguous and surrounds the central non-adhesive area.

3. The label in accordance with claim 1 wherein the border is discontinuous and surrounds the central non-adhesive area.

4. The label in accordance with claim 1 wherein an adhesive deadening agent is applied to the substrate inner surface to define the non-adhesive area.

5. The label in accordance with claim 3 wherein the adhesive is present in the border in discrete spaced locations.

6. The label in accordance with claim 1 wherein the carrier web has a frangible line extending therein, the frangible line being coextensive with the label non-adhesive area.

7. The label in accordance with claim 6 wherein the substrate is separable from the carrier web and wherein a portion of the carrier web underlying the substrate is separable from the carrier web at the frangible line.

8. The label in accordance with claim 1 wherein the substrate is in the shape of a rectangle having rounded corners and wherein the adhesive region is present having rounded corners inwardly of a periphery of the substrate.

9. The label in accordance with claim 1 wherein the carrier web is an elongated strip and wherein a plurality of substrates are carried by the carrier web, the substrates being spaced from one another along the carrier web.

10. The label in accordance with claim 9 wherein each of the plurality of substrates is separated from each of its adjacent substrates by frangible lines in the carrier web.

11. The label in accordance with claim 9 wherein the elongated strip is in a roll form.

12. The label in accordance with claim 9 wherein the elongated strip is in a fan-fold form.

13. A removable and repositionable label comprising a substrate carrier defining an indicia carrying surface and an adhering surface, the adhering surface having active adhesive area and a central non-adhesive area, the adhesive area defined by a border extending around a periphery of the non-adhesive area.

14. The removable and repositionable label in accordance with claim 13 wherein the border is contiguous and surrounds the central non-adhesive area.

15. The removable and repositionable label in accordance with claim 13 wherein the border is discontinuous and surrounds the central non-adhesive area.

16. The removable and repositionable label in accordance with claim 13 wherein an adhesive deadening agent is applied to the substrate inner surface to define the non-adhesive area.

17. The removable and repositionable label in accordance with claim 15 wherein the adhesive is present in the border in discrete spaced locations.

18. The removable and repositionable label in accordance with claim 13 wherein a liner material is carried on the adhering surface to define the non-adhesive area.

19. The removable and repositionable label in accordance with claim 18 wherein the portion of the liner material is separated from a carrier web.

20. The removable and repositionable label in accordance with claim 19 wherein the carrier web is in the form of an elongated strip in a roll form.

21. The removable and repositionable label in accordance with claim 19 wherein the carrier web is in the form of an elongated strip in a fan-fold form.
